(19) United States
(12) Patent Application Publication
(10) Pub. No.: US 2019/0194032 A1
(43) Pub. Date: Jun. 27, 2019

(54) Bottle with filter and air pump

(71) Applicant: Weijen WANG, Taipei City (TW)

(72) Inventor: Weijen WANG, Taipei City (TW)

(21) Appl. No.: 15/853,967

(22) Filed: Dec. 26, 2017

(51) Int. Cl. C02F 1/00; A45F 3/16

(52) U.S. Cl. CPC C02F 1/003; A45F 2003/163; C02F 2307/02; A45F 3/16

(57) ABSTRACT

A bottle generally includes a container body, a lid assembly, a filter, and an air pump. The container body defines therein an inner space. The lid assembly includes a top cover and a base portion, between which a chamber is defined. The base portion defines a first port and a second port. An outlet tube is connected to the first port at one end and extended out of the chamber at another end. The filter is located in the inner space of the container body and connected to the first port. The air pump is disposed in the chamber of the lid assembly and connected to the second port by an air tube for supplying air into the inner space of the container body to force the water contained in the container body to pass through the filter and flow out of the bottle via the outlet tube.

### (a) TECHNICAL FIELD OF THE INVENTION

The present invention relates to a bottle including a filter and an air pump which can force the water contained in the bottle to pass through the filter and flow out of the bottle.

### (b) DESCRIPTION OF THE PRIOR ART

Generally, river water or groundwater can be treated with various processes, such as sedimentation, filtration, and disinfection to become potable water. After the water has been processed in a water treatment plant to remove contaminants, the treated water may be polluted during its conveyance and distribution. It is therefore common practice to keep residual chlorine in the treated water to kill bacteriological contamination during distribution. Although the process of chlorination can effectively kill bacteria, it would cause halogenated hydrocarbons to be produced in the water. These chlorine-containing organic compounds are the main cause of human suffering from a variety of gastrointestinal cancers. For health, it is better to have the tap water further treated by a household water device.

The existing household water devices usually disinfect the tap water either by heating or filtering. In use, the tap water can be put into a container device, and then the water can be filtered and delivered out in manual way. This way of operation is inconvenient.

In view of the foregoing, there is a need to provide a water device, by which the water contained therein can be filted and delivered out automatically. After extensive investigation and numerous tests, applicant has contrived a bottle that can perform water filtration automatically.

### SUMMARY OF THE INVENTION

One object of the present invention is to provide a bottle, which can be carried easily and does not require an external independent filter.

To achieve the above object, the bottle generally comprises a container body, a lid assembly, a filter, and an air pump. The container body defines therein an inner space which opens out at a top opening, through which the container body can be filled with water. The lid assembly, which can be connected with the container body to close the top opening, basically includes a top cover and a base portion, between which a chamber is defined. The base portion defines a first port and a second port. An outlet tube is connected to the first port at one end and extended out of the chamber at another end. The filter is located in the inner space of the container body and connected to the first port of the lid assembly. The air pump is disposed in the chamber of the lid assembly and connected to the second port of the lid assembly by an air tube for supplying air into the inner space of the container body.

According to one feature of the present invention, a circuit board is disposed in the chamber of the lid assembly and provided thereon with control switches and pilot lights respectively for controlling and indicating the flow rate of water being delivered out of the bottle.

According to another feature of the present invention, the filter includes a nano-silver activated carbon tube, a nano-silver activated carbon unit under the activated carbon tube, and an ultrafiltration unit under the activated carbon unit, wherein the nano-silver activated carbon unit is provided at its two ends with two high-density cotton pads.

According to a further feature of the present invention, the ultrafiltration unit is formed of ultrafiltration hollow fiber membrane and defines inlets at an outer surface and a bottom thereof.

According to a still further feature of the present invention, the nano-silver activated carbon tube is furnished with a threaded portion at its top for being threaded into a threaded hole defined at the first port of the lid assembly. The ultrafiltration unit is provided with a thread portion at its top for being threaded into an inlet of the nano-silver activated carbon unit.

In operation, the lid assembly can be turned to be disconnected from the container body so that the container body can be filled with water, after which the container body can be again connected with the lid assembly. Next, the air pump can be started by switching one of the control switches to supply air into the inner space of the container body via the air tube, thus increasing the air pressure within the container body, so that the water contained in the container body can be forced to sequential pass through the ultrafiltration unit, the lower high density cotton pad, the nano-silver activated carbon unit, the upper high-density cotton pad, the nano-silver activated carbon tube, and finally the water can flow out of the bottle by way of the outlet tube to be suitable for drinking. After the bottle is used for a period of time, one or both of the nano-silver activated carbon unit and the ultrafiltration unit can be detached from the bottle to be cleansed or replaced by a new one.

Other objects, advantages, and novel features of the present invention will become more apparent from the following detailed description when taken in conjunction with the accompanying drawings.

### BRIEF DESCRIPTION OF THE DRAWINGS

FIG. 1 shows a schematically sectional view of a bottle according to one embodiment of the present invention.

FIG. 2 shows another schematically sectional view of the bottle.

FIG. 3 shows another schematically sectional view of the bottle, wherein a circuit board and a battery holder provided on an inner cover of a lid assembly are manifested.

FIG. 4 shows another schematically sectional view of the bottle, wherein an air pump and an outlet tube disposed on a base portion of the lid assembly are manifested.

FIG. 5 shows a schematic view of a filter used in the bottle.

FIG. 6 shows a working view of the bottle, wherein the air pump is stopped.

FIG. 7 shows another working view of the bottle, wherein the air pump is running to force the water to pass through the filter and flow out of bottle via the outlet tube.

FIG. 8 shows a schematically sectional view of a bottle according to another embodiment of the present invention.

### DETAILED DESCRIPTION OF THE PREFERRED EMBODIMENTS

To further understand the structure, features and advantages of the present invention, a preferred embodiment is illustrated with reference to the accompanying drawings in the following paragraph to enable persons of the relevant art to implement the present invention.

It should be recognized that the preferred embodiment is given for the purpose of illustration only and is not intended to limit the scope of the present invention and various modifications and changes, which will be apparent to those skilled in the relevant art, may be made without departing from the scope of the invention.

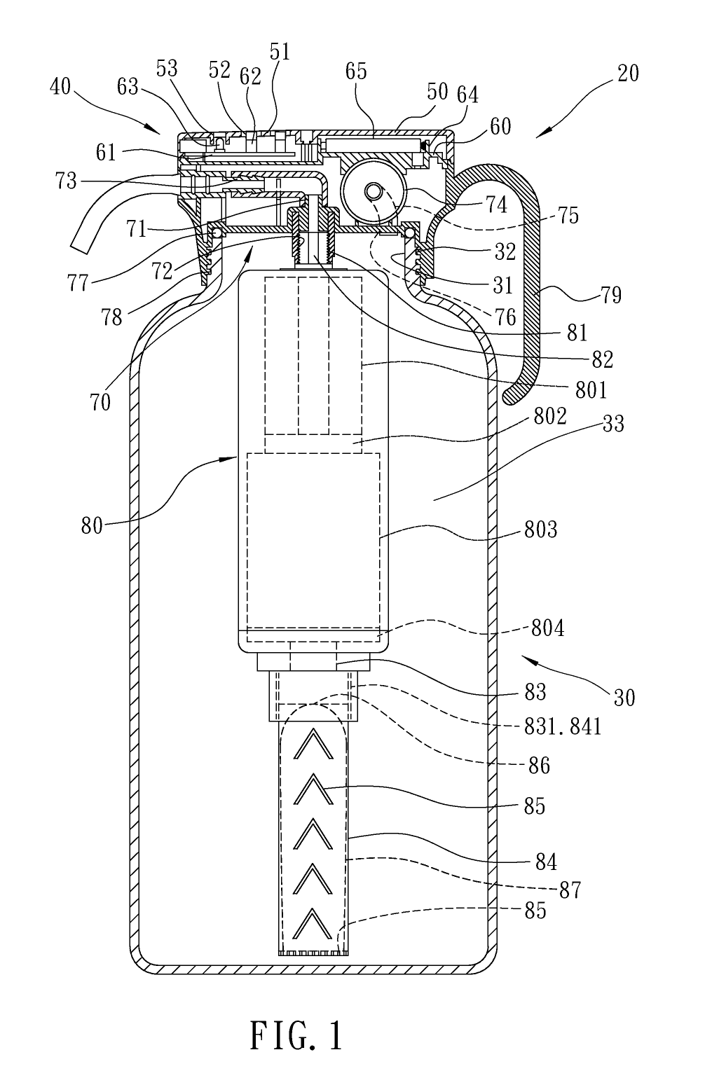

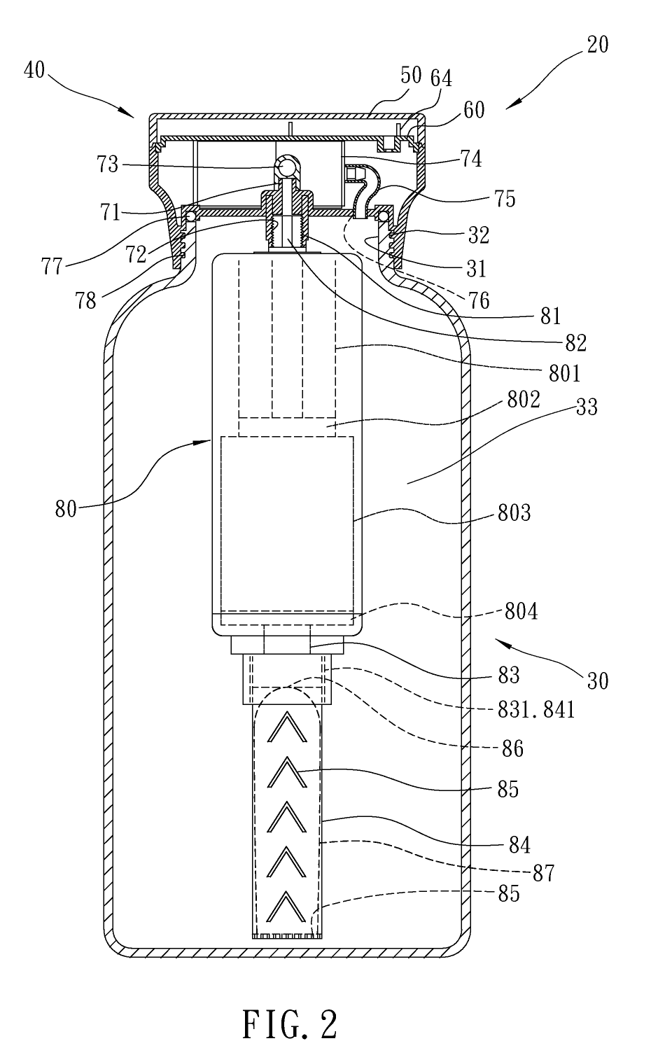

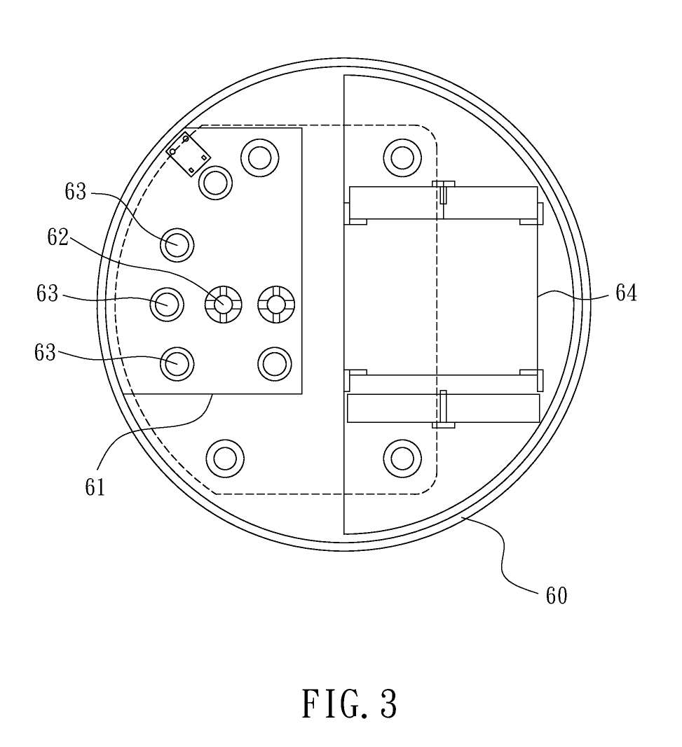

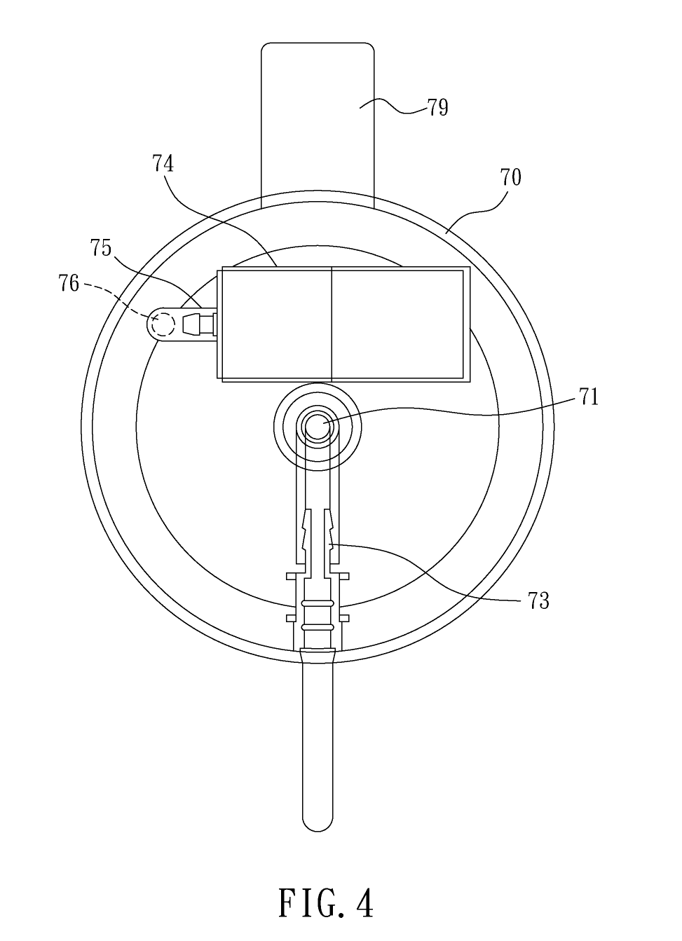

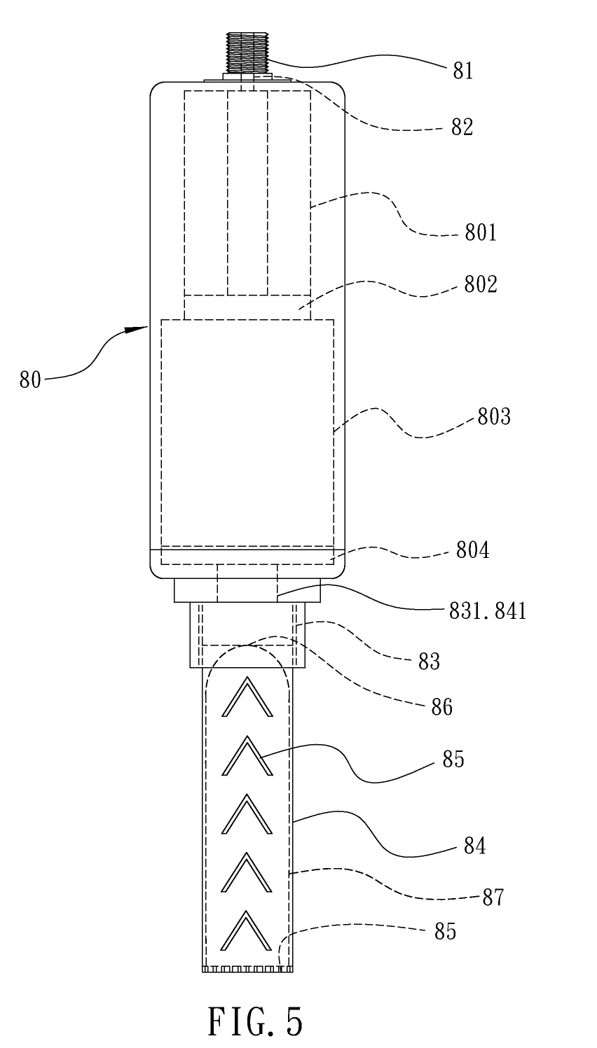

Referring to FIGS. 1 through 5, a bottle 20 according to one embodiment of the present invention is shown, which generally comprises a container body 30, a lid assembly 40, a filter 80, and an air pump 74. The container body 30 defines therein an inner space 33 which opens out at a top opening of a neck portion 31, through which the container body 30 can be filled with water. The lid assembly 40, which can be connected with the container body 30 to close the top opening, includes a top cover 50, an inner cover 60, and a base portion 70, wherein a chamber (not labeled) is defined between the inner cover 60 and the base portion 70. The top cover 50 is furnished with a control panel 51, which defines a plurality of holes 52, 53. The inner cover 60 is furnished with a circuit board 61 on which control switches 62 and pilot lights 63 are provided. In this embodiment, the control switches 62 are designed in the form of bottoms. The control switches 62 and the pivot lights 63 extend through the holes 52, 53 of the control panel 51. The circuit board 61 is electrically connected with the air pump 74. Also, the inner cover 60 is furnished with a battery holder 64, in which a battery 65 can be installed. The battery 65, which is electrically connected to the circuit board 61, can provide electrical energy required for the air pump 74 and electrical components of the circuit board 61. The base portion 70 is provided with a first port 71, which defines a threaded hole 72 towards the inner space 33 of the container body 30, and a second port 76. An outlet tube 73 is connected to the first port 71 at one end and extended out of the chamber defined between the inner cover 60 and the base portion 70. The air pump 74, which is provided in the chamber between the inner cover 60 and the base portion 70, can deliver air to the inner space 33 of the container body 30 via an air tube 75 connected between the air pump 74 and the second port 76. The base portion 70 is formed with a recessed portion (not labeled) at its bottom, wherein the recessed portion is provided with internal threads 78 to be in threaded engagement with the external threads 32 of the neck portion 31 of the container body 30 so that the top opening of the container body 30 can be closed. A seal ring 77 can be provided within the recessed portion of the base portion 70 to improve the sealing capability of the lid assembly 40. Furthermore, the base portion 70 is formed with a handle 79 for easily carrying the bottle. The filter 80, which is located in the inner space 33 of the container body 30, generally includes a nano-silver activated carbon tube 801, a nano-silver activated carbon unit 803 under the activated carbon tube 801, and an ultrafiltration unit 84 under the activated carbon unit 803. The nano-silver activated carbon tube 801 is provided at its top with a threaded portion 81, which defines therein an outlet hole 82 and can be put in threaded engagement with the threaded hole 72 of the base portion 70 of the lid assembly 40. The nano-silver activated carbon unit 803, which contains activated carbon particles (preferably with particle size between 20 and 40 of mesh number) mixed with nano-silver powders, defines at its bottom an inlet 83 and a threaded hole 831 under the inlet 83. Furthermore, the nano-silver activated carbon unit 803 is provided at its two opposite ends with two high-density cotton pads 802, 804. The ultrafiltration unit 84, which is formed of ultrafiltration hollow fiber membrane 87 for removing contaminants (such as bacteria), defines an outlet 86 at a top end 841 thereof, which can be threaded into the threaded hole 831 of the nano-silver activated carbon unit 803. Also, the ultrafiltration unit 84 can be made in the form of a cylinder and defines water inlet holes 85 at an outer surface and a bottom thereof.

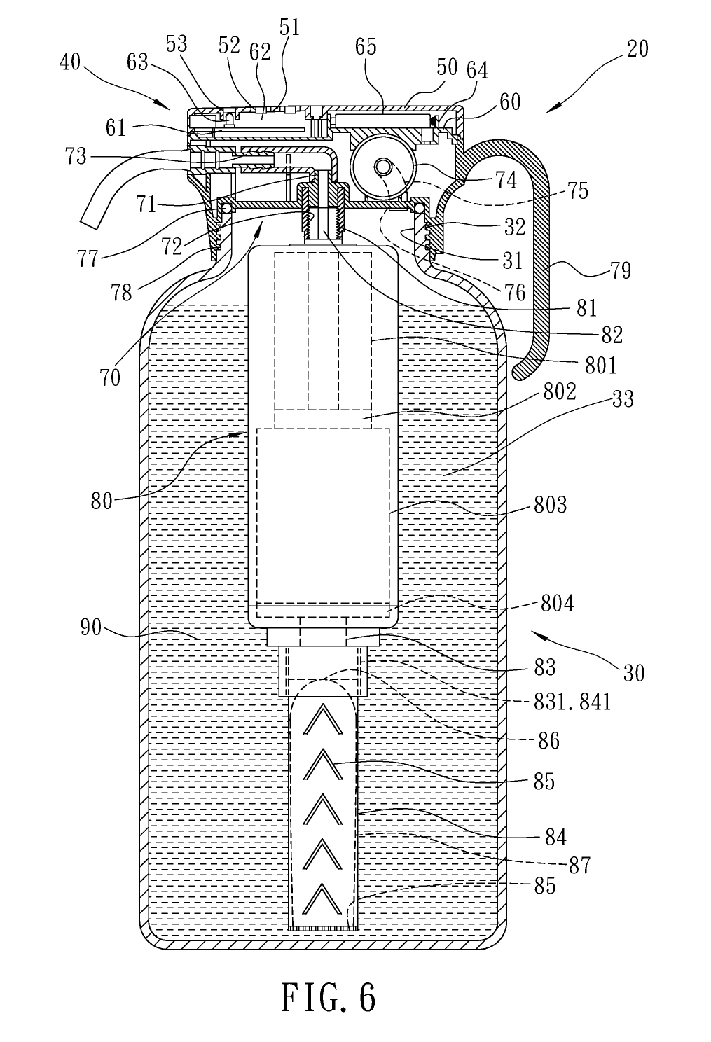

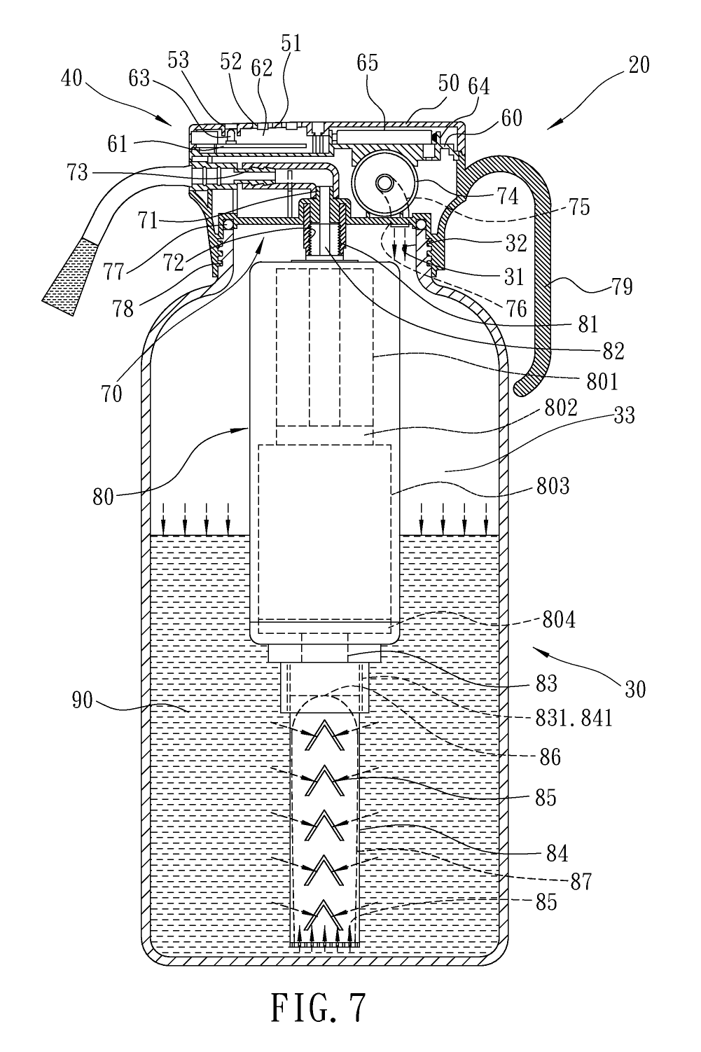

In operation, as shown in FIGS. 6 and 7, the lid assembly 40 can be turned to be disconnected from the container body 30 to have the container body 30 filled with water 90, and then the container body 30 can be again connected with the lid assembly 40. Thereafter, the air pump 74 can be started by switching one of the control switches 62 to supply air into the inner space 33 of the container body 30 by way of the air tube 75, thus increasing the air pressure within the container body 30, so that the water 90 contained in the container body 30 can be forced to sequential pass through the ultrafiltration unit 84, the lower high density cotton pad 804, the nano-silver activated carbon unit 803, the upper high density cotton pad 802, the nano-silver activated carbon tube 801, and finally the water 90 can flow out of the bottle by way of the outlet tube 73, and thus the water 90 is purified and suitable for drinking of course, the flow rate of water can be controlled through the control switches 62. The pilot lights 63 can be used to indicate the level of the water flow rate, wherein each pilot light represents a specific range of water flow rate. In addition, a pressure sensor can be provided at the air tube 75 to detect the air pressure within the container body 30; upon a high pressure is detected, the air pump 74 can be stopped automatically. Furthermore, after the bottle is used for a period of time, either the nano-silver activated carbon unit 803 or the ultrafiltration unit 84 can be detached from the bottle to be cleansed or replaced by a new one.

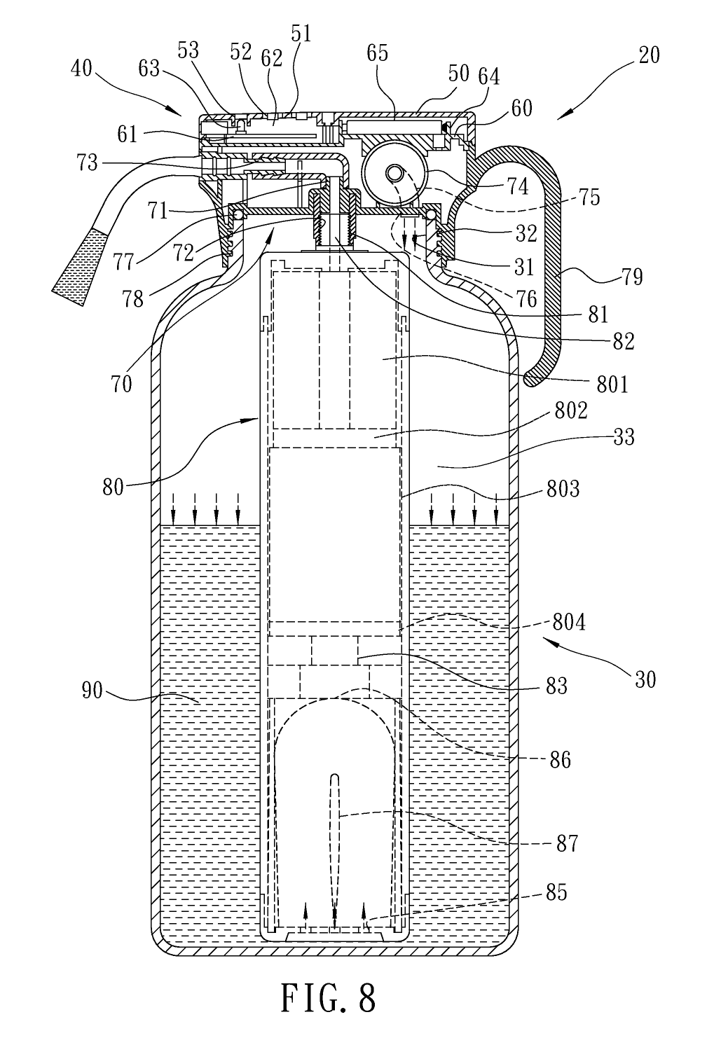

FIG. 8 shows another embodiment of the present invention, which is same as the previous embodiment except that the ultrafiltration unit 84 is formed integrally with the nano-silver activated carbon unit 803. This feature may facilitate replacing the filter.

As a summary, the bottle of the present invention is easy to carry and contains therein a filter that can be replaced easily, and the water contained in the container body can be filtered through the filter and delivered out of the bottle automatically. These features render the bottle of the present invention useful and creative.

What is claimed is:

1. A bottle, comprising:
a container body defining therein an inner space which opens out at a top opening, through which the container body can be filled with water;
a lid assembly capable of being connected with the container body for closing the top opening, the lid assembly including a top cover and a base portion, between which a chamber is defined, wherein the base portion defines a first port and a second port, and an outlet tube is connected to the first port at one end and extended out of the chamber at another end;
a filter located in the inner space of the container body and connected to the first port of the lid assembly; and
an air pump disposed in the chamber of the lid assembly and connected to the second port of the lid assembly by an air tube for supplying air into the inner space of the container body;
whereby, when the air pump is running, the water contained in the container body can be filtered through the filter and flow out of the container body by way of the outlet tube.

2. The bottle of claim 1, wherein the base portion of the lid assembly is formed with a handle for easy carrying the bottle, and formed with internal threads for threaded connection with external threads of the container body; a seal ring is provided between the lid assembly and the container body.

3. The bottle of claim 1, wherein the filter includes a nano-silver activated carbon unit connected to the first port of the lid assembly.

4. The bottle of claim 3, wherein the nano-silver activated carbon unit is provided with two high-density cotton pads at two opposite ends thereof.

5. The bottle of claim 4, wherein the filter further includes an ultrafiltration unit connected to or formed integrally with a bottom of the nano-silver activated carbon unit, the ultrafiltration unit being formed of ultrafiltration hollow fiber membrane.

6. The bottle of claim 5, wherein a circuit board is disposed in the chamber of the lid assembly and electrically connected with the air pump and provided thereon with switches and pilot lights extending though two holes of the top cover of the lid assembly respectively for controlling and indicating the flow rate of water flowing out of the outlet tube.

7. The bottle of claim 6, wherein a battery is provided in the chamber of the lid assembly and electrically connected to the circuit board.

8. The bottle of claim 5, wherein the first port of the lid assembly defines a threaded hole; the filter further includes a nano-silver activated carbon tube on top of the nano-silver activated carbon unit, the nano-silver activated carbon tube provided with a threaded portion to be in threaded engagement with the threaded hole of the lid assembly.

9. The bottle of claim 8, wherein the nano-silver activated carbon unit defines a threaded hole at a bottom thereof; the ultrafiltration unit is provided with a threaded portion at a top thereof to be in threaded engagement with the threaded hole of the nano-silver activated carbon unit.

10. The bottle of claim 9, wherein the ultrafiltration unit is made in the form of a cylinder and defines water inlet holes at an outer surface and a bottom thereof.
